(19) United States
(12) Patent Application Publication
(10) Pub. No.: US 2004/0223629 A1
(43) Pub. Date: Nov. 11, 2004

(54) Facial surveillance system and method

(75) Inventor: Jung-Chou Chang, Hacienda Heights, CA (US)

Correspondence Address: BACON & THOMAS, PLLC, 625 SLATERS LANE, FOURTH FLOOR, ALEXANDRIA, VA, 22314

(73) Assignee: Viswis, Inc., Taipei (TW)

(21) Appl. No.: 10/429,720

(22) Filed: May 6, 2003

(51) Int. Cl. G06K 9/00

(52) U.S. Cl. 382/118

(57) ABSTRACT

The present invention discloses a facial surveillance system and method. In this system and method, if a plurality of facial features can be found on a candidate facial area, further detection will be carried out to find any anomaly feature such as a mask, sun glasses or a helmet. Accordingly, potential criminal events may be effectively prevented.

### BACKGROUND OF THE INVENTION

1. Field of the Invention

The present invention relates generally to a facial surveillance system and method, and more particularly to a facial surveillance system and method which may effectively prevent potential criminal events.

2. Description of the Related Art

A total security solution for a crime fighting or prevention system usually consists of three respects—before, during, and after a criminal event. The “before” part of the system is mainly to prevent or deter criminal actions from happening. The “during” part of the system is to detect and stop criminal actions. The “after” part of the system is to provide legal remedies such as non-repudiation evidence.

The “before” and “after” parts of said total security solution relate generally to a surveillance system. For example, in an automated teller machine (ATM) area of a bank, the surveillance system could comprise security guards at the entrance area, video surveillance systems installed near or inside the ATMs. The video surveillance system is usually comprised of at least one video camera, a recording device such as a video cassette recorder (VCR) or a digital video recorder (DVR), and optionally a monitoring station watched by a security guard at a remote or centralized location.

The “during” part of said total security solution relates generally to an access control system. For example, ATMs might use biometric means, such as fingerprint scan or iris scan, as a better access control to enhance the authentication over the use of the conventional means such as personal identification number (PIN).

The main problems with the conventional video surveillance systems are that not only they are expensive, but also they often record blurred images therefore render useless information as evidence. Video cameras used in conventional video surveillance systems are frequently called CCTV cameras. They are often placed in a corner of a room looking across the whole room. With current NTSC or PAL video formats, CCTV cameras with standard lens simply don't have enough video resolution to capture a clear facial image if the subject is a few meters away from the cameras or simply looks away from the cameras. This is why we have often seen on TV some video playbacks recorded at crime scenes are of no good use because either the videos were too blurred, or the faces of criminals on tape were disguised by face masks or alike. Therefore, although the posted in-use sign of a video surveillance system does receive some deterrence benefits, but the problems stated above greatly reduce the system's effectiveness.

For the “during” part of said total security solution, solutions for better access control are currently evolving very rapidly. The conventional way of access control, sometimes called user authentication, utilizes passwords or PINs—they are well-known for many drawbacks: such as high maintenance cost, frequently forgotten, misplaced, easy to guess or crack, etc. This is why many financial transactions or high security applications have now required biometric authentication as access control. But even the considered highest accuracy devices such as fingerprint scanners and iris scanners, they are not totally fool proof. The main drawbacks associated with these biometric devices are that they always have small fractions of so-called false acceptances rate and false rejections rate. Although these rates are usually within the range of 0.1% and 3%, depending upon the biometrics used, this can still be unacceptable for banks.

One solution to overcome such unacceptable inconvenience caused by false rejections and false acceptances of a biometric device is to record an individual customer's actual transaction history as a predictive means. However, a customer with few transactions history will receive less reliable predictive help.

Another solution for improving the effectiveness of a video monitoring system is to report only images of non-authorized person. Such system relies on a pre-trained facial database to determine if an intruder is authorized or not. However, the false acceptances and false rejections of the facial identification method the system relies on often cause many incorrect and annoying crime reports.

An event-triggered video recording system is another developed technology. This system can be triggered to record images only when certain events such as opening a door, occur. Unfortunately, this arrangement still can't prevent the system from recording ineffective images.

Moreover, a biometric access control system can be improved by taking environment variables into account to improve accuracy thereof. Nevertheless, significant inconvenience caused by false rejections still exists in such biometric identification means.

Within the face recognition research community, face recognition is known to be more difficult than face detection. Face detection has only two classes: face or nonface. Face recognition has M classes, where each class represents one person from M individuals. Recognition is difficult because of variations in factors such as lighting conditions, viewpoint, body movement and facial expression.

In these respects, the facial surveillance system according to the present invention substantially departs from the conventional concepts and designs of the prior arts, and in so doing provides an apparatus primarily developed for the purpose of capturing the most useful surveillance data: the facial images. For an access control system, the present invention can provide not only valid facial images for logging purpose, but also a more reliable access control method based on simply whether a clear facial image is captured. The present invention has a greater deterrent effect (the “before” part) and greater remedy power (the “after” part) than conventional surveillance systems; it's like a robot security guard saying: “show your face or else.”

### SUMMARY OF THE INVENTION

An object of the present invention is to provide a facial surveillance system and method which can prevent potential criminal events.

Another object of the present invention is to provide a facial surveillance system and method which demands lower cost and less human resources.

In order to achieve the above objects, the facial surveillance system primarily includes an image processing means for finding a candidate facial area from an image, a facial feature detection means for detecting if said candidate facial area contains a plurality of facial features, an anomaly feature detection means for detecting if said candidate facial area contains at least one anomaly feature, and a decision means for determining whether a valid or invalid face is detected based upon results of said facial feature detection means and/or said anomaly feature detection means.

The facial surveillance method of the present invention primarily includes steps of: a) processing an image to find a candidate facial area; b) determining if said candidate facial area contains a plurality of facial features, if yes, go to step c), and if not, skip to step d); c) determining if said candidate facial area contains at least one anomaly feature or none; and d) outputting a signal based upon said step b) and/or step c).

The image processing means and the facial feature detection means or the steps a) and b) aforementioned can be designed according to any developed mechanism, for example, neural network analysis, principal component analysis (PCA), and eigentemplates. The anomaly feature detection means or step c) can be designed or achieved also according to any developed mechanism, for example, neural network analysis, color analysis, texture analysis or shape analysis.

The anomaly feature can be any object covering at least one of said facial features, for example, dark sun glasses, a mask and a helmet.

The present invention may further include a signal receiving means for receiving a decision signal from the decision means or the step d). The signal receiving means can be an access controller, a data storage means or a printing device. The access controller can be an alarm or a speaker, a switch for shutting off secured target from a suspect, etc.

Additional benefits and advantages of the present invention will become apparent to those skilled in the art to which this invention relates from the subsequent description of the preferred embodiment and the appended claims, taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 shows a general process of the present invention; and

FIG. 2 shows a block diagram of a facial surveillance system in accordance with another embodiment of the present invention.

### DETAILED DESCRIPTION OF THE PREFERRED EMBODIMENT

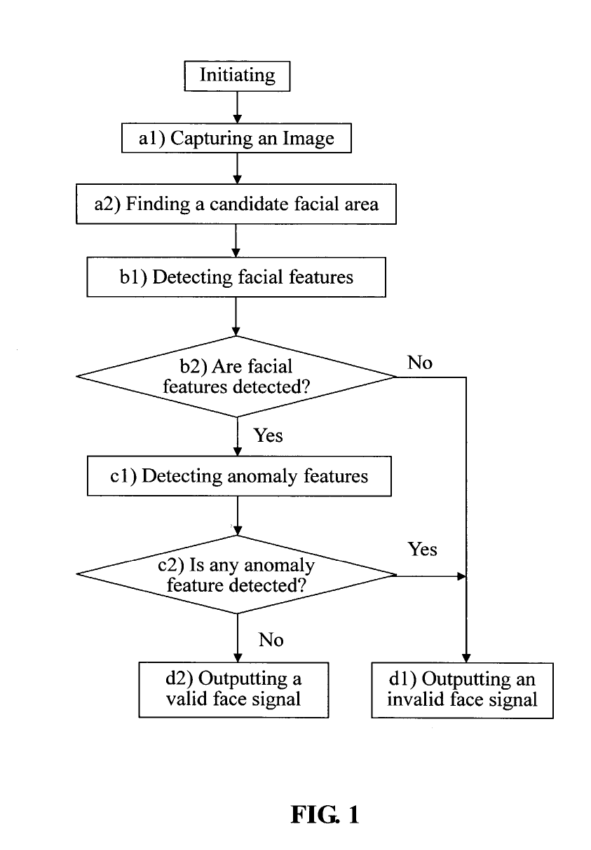

FIG. 1 shows a general process of the present invention. First, the process can be typically initiated with a sensor when a person is present within the working area thereof. The sensor can trigger an image capturing means such as a video camera, to generate an image in step a1). In step a2), the image is processed by an image processing means to find a candidate facial area. In the present invention, types of the image data are not restricted to, for example, digital pictures, digital video, analog video, image files, etc. The image processing means can be designed according to an algorithm method such as eigentemplates or neural networks. The algorithms for face detection are readily known in the art.

In step b1), the candidate facial area is processed by a facial feature detection means to find a plurality of facial features such as eyes, nose, mouth, facial outline, skin tone, etc. Step b2) shows a decision making step to determine whether an invalid face is detected. If no plurality of facial features are found in step b1), i.e., an invalid face is detected, then go to step d1). In step d1), an invalid face signal is generated, and might further trigger an access controller to restrain the person from access. The invalid face signal can be also optionally sent to a printer for printing related data, for example, the decision, reasons for generating such result, the facial image, full-frame image containing facial image, timestamp, duration to reach the result, ambient lighting condition, and other system parameters. These data also can be saved in a storage means or memory.

On the other hand, if more than one facial features are found in step b1), i.e., a valid face “could” be detected, then go to step c1) for further detection. In step c1), an anomaly feature detection means continues to look for anomaly features such as a facial mask, dark sun glasses, a helmet, and any object that covers up a substantial portion of the facial region. In this step, a liveliness test could also be performed, in case a person is holding up someone else's photo in front of a video camera. The liveliness test is often an interactive process that requires the person to do a spontaneous response, such as blinking eyes, on cue. Step c2) is another decision making step for determining if a valid face can be detected. If no anomaly feature is detected in step c1), i.e., a valid face is detected, then a valid face signal is generated in step d2). The valid face signal may allow the person access or continue other operation. The printer and the storage means may optionally be enabled to print and save the related data. Once an anomaly feature is detected, an invalid face signal will be generated in step d1) for triggering the access controller for further actions. The printer and the storage means can be also enabled to print and save the related data.

In the present invention, the facial feature detection means and the anomaly feature detection means can be also designed according to the algorithm method such as eigentemplates, neural networks analysis, color analysis, texture analysis, or shape analysis.

Let's consider using the facial surveillance system and method of the present invention in conjunction with an ATM machine, the system can be initiated by an external event such as ATM card insertion. If the method of the present invention detects a clear facial image and hence generates a valid face signal, the valid signal will enable the ATM machine to allow an ATM user to continue an ATM transaction. If the method generates an invalid face signal, the output data might include a reason for explaining why the invalid signal was generated so that the ATM user could take a corrective action such as taking his/her sun glasses off. An impostor wearing a facial mask would have to think twice whether to reveal his/her face in this situation. This preferred embodiment demonstrates what great benefits of deterrence and non-repudiation evidence the present invention can bring.

The output data also comprise, depending upon the generated signal and system preference, a valid facial image, a full-frame image containing the valid facial image, a full-frame image containing an invalid facial image, a time stamp, and other relevant environmental information. The output data especially the valid facial images provide a significant improvement over the existing surveillance system in terms of picture quality, effectiveness, non-repudiation, and low cost. Recording only the valid facial images and only when the system is initiated, the requirement of storage size can be greatly reduced at an estimated 1000 times or more! Even a low-cost removable memory card, such as Compact Flash (CF) memory card, can easily store a full-month worth of facial images.

Further disclosed, the system can be used in conjunction with other existing access control system. For example, the system can be used as a first defense access control system, followed by a biometric access control system. The facial surveillance system complements other access control methods extremely well by providing the “before” (i.e. deterrence) and “after” (i.e. evidence) parts of a total security solution.

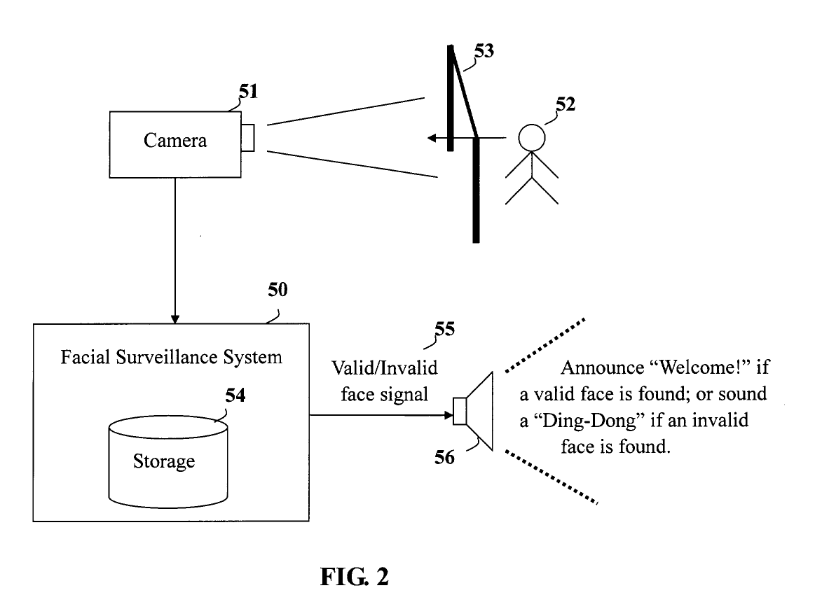

Referring now to FIG. 2, another embodiment is shown. Many shop owners prefer to install an infrared detector at entrance to remind them of incoming customers, in conjunction with a video camera aiming at the entrance for surveillance purpose. An infrared detector simply sounds a ding-dong melody when people walking across the line of detection. The facial surveillance system 50 could replace both the infrared detector and the conventional video surveillance system, to provide a better and low-cost surveillance solution. The system 50 can constantly monitor the entrance area and look for valid facial images. When a customer 52 walks across the door 53 and gets detected by the system 50, if a valid facial image captured by the camera 51 is detected, and optionally saved into storage 54, a valid signal 55 can drive a speaker 56 to announce “Welcome!” in a synthesized human voice. If there's no valid facial image detected, an invalid signal 55 will drive the speaker 56 to sound a “Ding-Dong” melody to alert the shop owner to take a glance, just in case! Now the system 50 of the present invention may alleviate tension of the shop owner who usually has to watch at incoming customers all the time. The greatest advantage of the present invention is to provide more focused surveillance—just looking for clear and valid facial images—which happens to be the most important factor for a crime fighting system. A clearly recorded facial image can be steadily recognized by people and facilitate catching a criminal by broadcasting this clear facial image on TV.

Although the invention has been described with particular reference to preferred embodiments thereof, variations and modifications of the present invention can be effected within the spirit and scope of the following claims.

What is claimed is:

1. A facial surveillance system, comprising:
an image processing means for finding a candidate facial area from an image;
a facial feature detection means for detecting if said candidate facial area contains a plurality of facial features;
an anomaly feature detection means for detecting if said candidate facial area contains at least one anomaly feature; and
a decision means for determining whether a valid or invalid face is detected based upon results of said facial feature detection means and/or said anomaly feature detection means.

2. The facial surveillance system of claim 1, wherein said image processing means finds said candidate facial area by neural network analysis.

3. The facial surveillance system of claim 1, wherein said image processing means finds said candidate facial area by principal component analysis (PCA) or eigentemplates.

4. The facial surveillance system of claim 1, wherein said anomaly feature detection means is to detect an object covering at least one of said facial features.

5. The facial surveillance system of claim 1, wherein said anomaly feature detection means is to detect at least one of dark sun glasses, a mask and a helmet on said candidate facial area.

6. The facial surveillance system of claim 1, which further comprises a signal receiving means for receiving a decision signal from said decision means.

7. The facial surveillance system of claim 6, wherein said signal receiving means is an access controller.

8. The facial surveillance system of claim 6, wherein said signal receiving means is a data storage means.

9. The facial surveillance system of claim 6, wherein said signal receiving means is a printing device.

10. A facial surveillance method, comprising steps of:
a) processing an image to find a candidate facial area;
b) determining if said candidate facial area contains a plurality of facial features, if yes, go to step c), and if not, skip to step d);
c) determining if said candidate facial area contains at least one anomaly feature or none; and
d) outputting a signal based upon said step b) and/or step c).

11. The facial surveillance method of claim 10, wherein said step a) is achieved by neural networks analysis.

12. The facial surveillance method of claim 10, wherein said step a) is achieved by principal component analysis (PCA) or eigentemplate analysis.

13. The facial surveillance method of claim 10, wherein said step b) is achieved by neural networks analysis.

14. The facial surveillance method of claim 10, wherein said step b) is achieved by principal component analysis (PCA) or eigentemplate analysis.

15. The facial surveillance method of claim 10, wherein said step c) is to detect an object covering at least one of said facial features.

16. The facial surveillance method of claim 10, wherein said step c) is to detect at least one of dark sun glasses, a mask, a helmet.

17. The facial surveillance method of claim 10, wherein said step c) is achieved by neural network analysis.

18. The facial surveillance method of claim 10, wherein said step c) is achieved by color analysis, texture analysis or shape analysis.

19. The facial surveillance method of claim 10, wherein said step d) is to output said signal to an access controller.

20. The facial surveillance method of claim 10, wherein said step d) is to output said signal to a storage means.

21. The facial surveillance method of claim 10, wherein said step d) is to output said signal to a printing device.
